(19) United States
(12) Patent Application Publication
(10) Pub. No.: US 2009/0094596 A1
(43) Pub. Date: Apr. 9, 2009

(54) SYSTEMS AND METHODS FOR AN ADAPTIVE INSTALLATION

(75) Inventors: Richard Kuiper, Barendrecht (NL); Dennis Van Eijk, Oirlo (NL)

Correspondence Address: CHOATE, HALL & STEWART LLP, TWO INTERNATIONAL PLACE, BOSTON, MA, 02110, US

(73) Assignee: Scense B.V., PR Rotterdam (NL)

(21) Appl. No.: 12/054,079

(22) Filed: Mar. 24, 2008

Related U.S. Application Data
(60) Provisional application No. 60/978,001, filed on Oct. 5, 2007.

(51) Int. Cl. G06F 9/445

(52) U.S. Cl. 717/174

(57) ABSTRACT

The present solution addresses conflicts and incompatibilities between an installation and the files or components existing on a computer at the time and point of installation. The adaptive installation technique of the present solution performs real-time cross referencing of the files and components to be installed with the current environment of the computer where the application is to be installed. In this manner, only actual or real conflicts at the point and time of installation and in view of the current environment are resolved. The present solution dynamically adapts the installation instructions of the installer at the installer's run time to prevent or avoid conflicts and incompatibilities that may exist on the computer targeted for the installation. This adaptive technique adapts the installation instructions specifically for the computer environment at the time of install and s suitable for this computer.

### RELATED APPLICATIONS

This present application claims priority to U.S. Provisional Patent Application No. 60/978,001, entitled “Systems and Methods for an Adaptive Installation,” filed Oct. 5, 2007, which is incorporated herein by reference.

### FIELD OF THE INVENTION

The present application is generally directed towards systems and methods for automatically and adaptively installing an application to avoid conflicts.

### BACKGROUND

In many cases, an installation program is used to install, configure and uninstall applications on a computer. For example, the Windows Installer from Microsoft Corporation is such an industry standard installation, configuration and uninstall facility. A software developer can create an installation file for the Windows Installer that contains the files and settings for the application. The installation file may also include instructions on how to install the application. The software developer or supplier typically creates an installation file that will install their application in a way that will most certainly work. In some cases, the installation process will require a system reboot that may not be really necessary. Often these software developers or suppliers are not concerned if their installation process breaks other installed applications. Although the software developer's application is installed correctly from the software developer's installation, other applications may no longer work on the computer.

### SUMMARY

The present solution addresses conflicts and incompatibilities between an installation and the files or components existing on a computer at the time and point of installation. The adaptive installation technique of the present solution performs real-time cross referencing of the files and components to be installed with the current environment of the computer where the application is to be installed. In this manner, only actual or real conflicts at the point and time of installation and in view of the current environment are resolved. The present solution dynamically adapts the installation instructions of the installer at the installer's run time to prevent or avoid conflicts and incompatibilities that may exist on the computer targeted for the installation. This adaptive technique adapts the installation instructions specifically for the computer environment at the time of install and in a manner suitable for the target computer.

The adaptive techniques of the present solution reduces or avoids the labor intensive process of administrators resolving installation conflicts and incompatibilities on a computer by computer basis. The present solution further reduces the need of administrators to customize, modify or maintain various installation instructions or installer packages for an application to be installed on different computing environments. Typically, software developers or suppliers do not include any isolation instructions into their installation files unless they need it to get their own application to work. Administrators may only apply isolation to installation files if they know which components will conflict. In order to know which components may conflict, the administrator may keep a repository of all installation files and their content and do a cross reference check. This can be very labor intensive as new applications and versions of applications are continuously introduced and even previous versions recalled or returned. In user based environments, where applications may be installed if and when the user wants to use the application, the administrator will be challenged to know which combination of applications will eventually exist on any given computer. The administrator may probably be solving conflicts that never actually exist on the computer at the time of installation.

With the present solution, the same installer and installation instructions may be adapted with isolation instructions real-time and on the fly to the specific target computer. The isolation instructions may be adapted to the installation process in a non-intrusive manner and in a manner that maintains the installer's functionality in handling these isolation instructions, such as repair and uninstall functions. In a user based environment, where users may roam from computer to computer to access an application, the adaptive installation technique enables the application to be installed on demand in a manner seamless and transparent to the user and/or install program.

In one aspect, the present invention is related to a method for adaptively modifying an installation process at a time of install to isolate conflicts between components to be installed and existing components. The method includes a client agent detection initiation of execution of an installer on a client and intercepting execution of the installer in response to the detection. The installer may obtain installation instructions via an install file. The client agent determines existence of a conflict between each of one or more components identified via the installation instructions and one or more components existing on the client. In response to the determination, the client agent modifies the installation instructions to include an isolation instruction for each determined conflict. The client agent resumes the intercepted execution of the installer using the modified installation instructions.

In some embodiments, the client agent compares each component identified in the install file or installation instructions to corresponding components existing on the client. The client agent may detect the initiation of execution of a Windows Installer program. In one embodiment, the client agent suspends the execution of the installer program in response to the detection. In other embodiments, the client agent stops execution of the installer in response to determining a conflict. The agent may restart the intercepted execution of the installer upon completing modifications to the installation instructions for each of the determined conflicts. The agent may seamlessly or transparently continue the intercepted execution of the installer. The agent may continue the intercepted execution of the installer with the modified installation instructions.

In one embodiment, the client agent inserts in the installation instructions a first isolation instruction in response to determining existence of a first conflict. The client agent may insert in the installation instructions a first isolation instruction identifying a manifest file in response to determining the existence of a first conflict. The client agent may generate a manifest file in response to determining the existence of a first conflict. The manifest file may include an Extensible Markup Language structure identifying one or more components to pre-load and a location for each of the one or more components. The isolation instruction may comprise an instruction to resolve a first determined conflict between a first identified component to be installed and a corresponding component existing on the client. The client agent may modify the installation instructions in memory or stored in the install file.

In another aspect, the present invention is related to a system for adaptively modifying an installation process at a time of install to isolate conflicts between components to be installed and existing components. The system includes a detector to detect initiation of execution of an installer on a client and an interceptor to intercept execution of the installer in response to response to the detector. The installer may obtain installation instructions via an install file. The system may include a comparator to compare each of one or more components identified via the installation instructions and one or more components existing on the client to determine existence of a conflict. The system also includes an isolation instruction generator to generate an isolation instruction responsive to the comparator. An agent modifies the installation instructions to include an isolation instruction for each determined conflict and to continue the intercepted execution of the installer using the modified installation instructions.

In some embodiments, the comparator searches for an existing component on the client corresponding to each component identified in the install file. In one embodiment of the system, the detector detects initiation of execution of a Windows Installer program. The agent or the interceptor may suspend execution of the installer in response to the detector. In another embodiment, the interceptor or the agent stops execution of the installer in response to the comparator identifying a conflict. The agent may seamlessly or transparently continue the intercepted execution of the installation instructions, such as upon completion of the modification to the installation instructions.

In other embodiments, the isolation instruction generator generates a first isolation instruction in response to determining existence of a first conflict. The isolation instruction generator generates an isolation instruction to resolve a first determined conflict between a first identified component to be installed and a corresponding component existing on the client. The isolation instruction generator may generate a first isolation instruction identifying a manifest file in response to the comparator determining the existence of a first conflict. The isolation instruction generator may generate a manifest file in response to the comparator determining the existence of a first conflict. The manifest file may include an Extensible Markup Language structure identifying one or more components to pre-load and a location for each of the one or more components.

The details of various embodiments of the invention are set forth in the accompanying drawings and the description below.

### BRIEF DESCRIPTION OF THE FIGURES

The foregoing and other objects, aspects, features, and advantages of the invention will become more apparent and better understood by referring to the following description taken in conjunction with the accompanying drawings, in which:

FIG. 1A is a block diagram that depicts an overview of an embodiment of an environment in which session control management may be provided;

FIG. 1B is a block diagram that depicts an embodiment of a session control system;

FIG. 1C is a block diagram that depicts another embodiment of a session control system;

FIG. 1D is a flow diagram that depicts an embodiment of steps of a method for providing session control between logon and logoff;

FIGS. 1E and 1F are block diagrams of an embodiment of a computing device;

FIG. 2A is a block diagram of an embodiment of a database of the session control management system;

FIG. 2B is a block diagram of an embodiment of an administration tool for the session control management system;

FIG. 2C is a block diagram of another embodiment of an administration tool for the session control management system;

FIG. 2D is a block diagram of an embodiment of access control lists for an administration tool for the session control management system;

FIG. 2E is a block diagram of an embodiment of a wizard of the administration tool for the session control management system;

FIG. 3A is a block diagram of an embodiment of an adaptive installation system; and

FIG. 3B is a flow diagram depicting an embodiment of steps of a method for performing an adaptive installation technique.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

For purposes of reading the description of the various embodiments of the present invention below, the following descriptions of the sections of the specification and their respective contents may be helpful:
Section A describes a session control and computing environment useful for practicing an embodiment of the present invention;
Section B describes embodiments of systems and methods of providing a central administration tool, database and application wizard; and
Section C describes embodiments of systems and methods of providing an adaptive installation technique.

### A. Session Control Management and Computing Environment

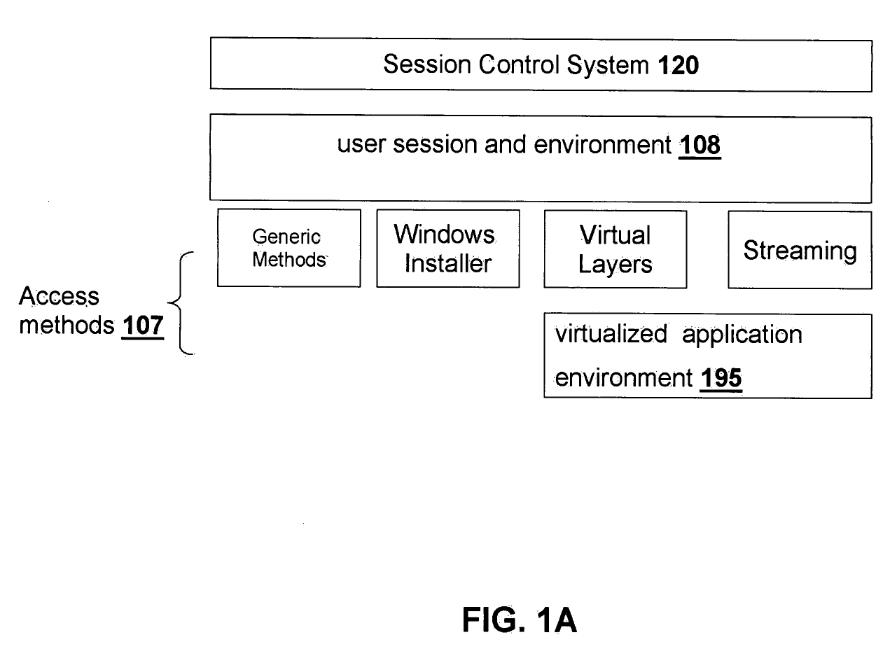

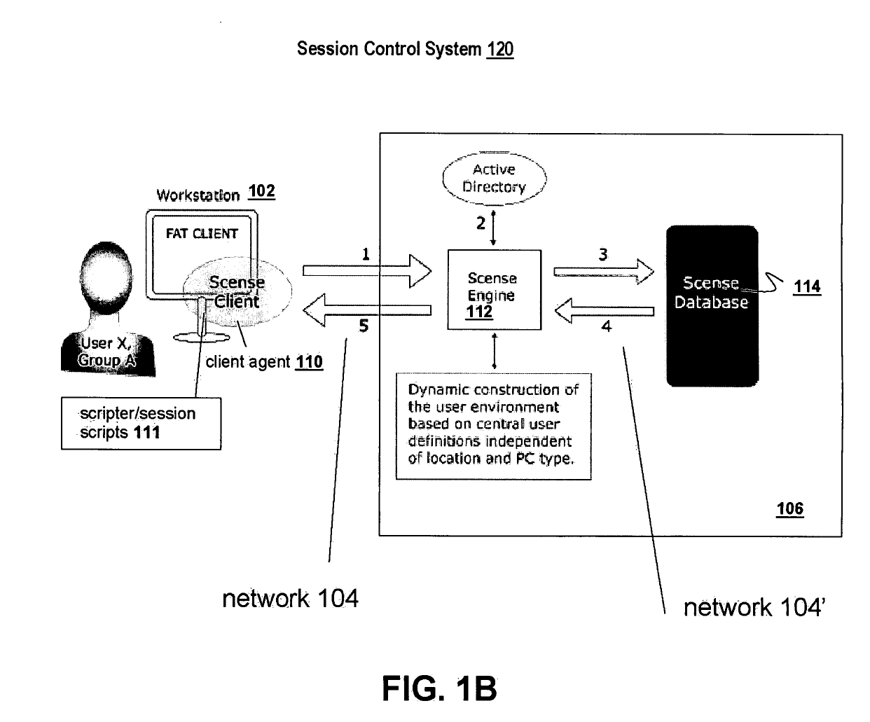

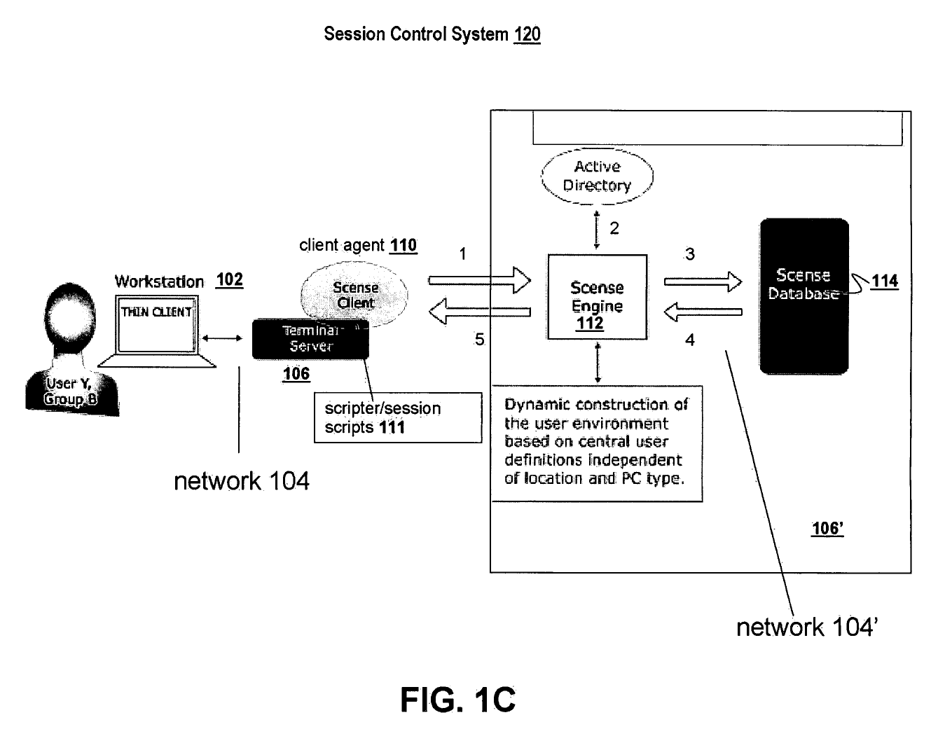

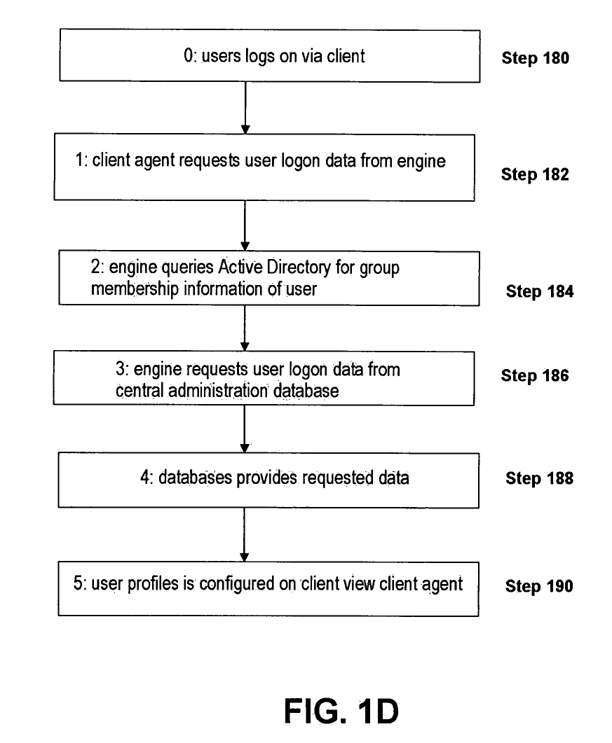

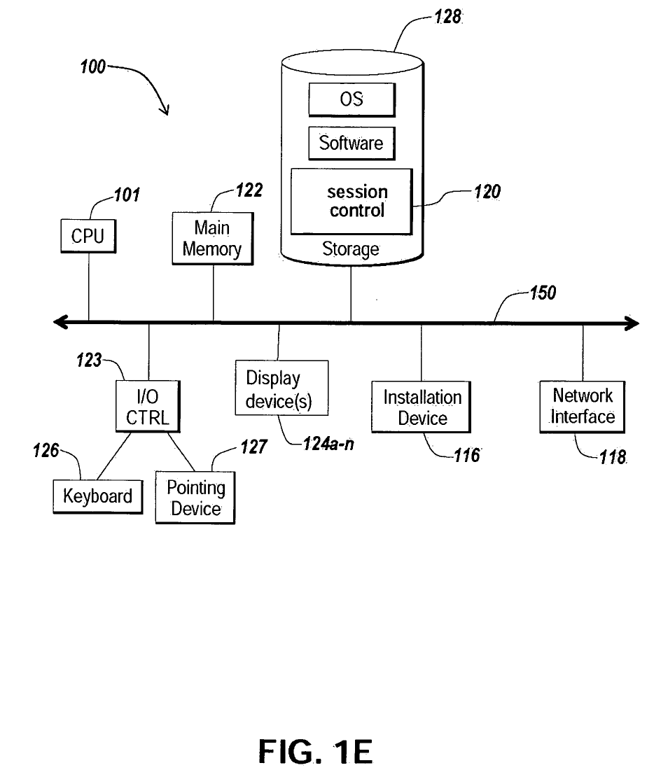

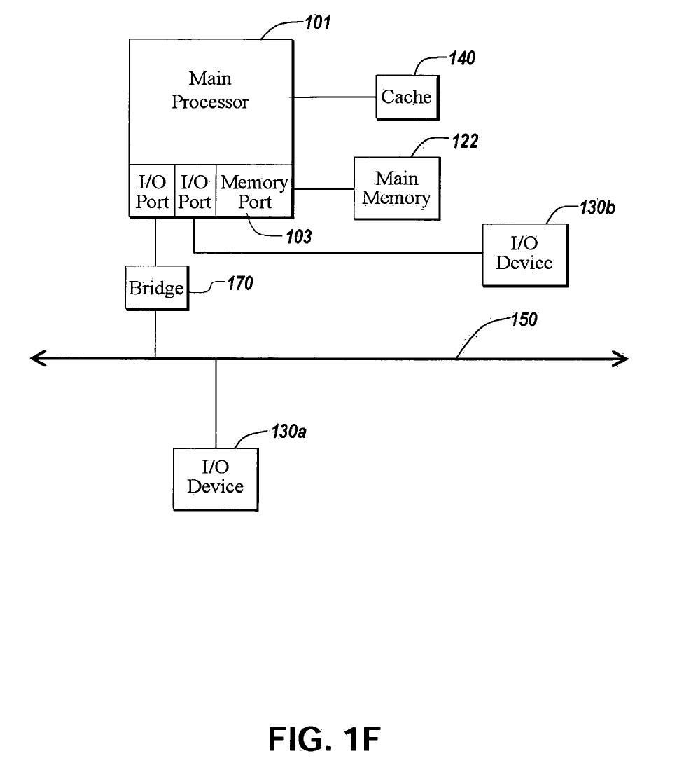

Prior to discussing the specifics of embodiments of the systems and methods for providing adaptive installation techniques, it may be helpful to discuss the processing and computing environments in which such embodiments may be deployed. Referring now to FIG. 1A, an embodiment of an environment for session control management is depicted. In brief overview, the session control system 120 may provide a system for dynamically controlling a session and an environment 108 of a user. During a session, a user may use any one or more methods of access 107 to deploy, use or access an application. In turn, an application may access the operating system which provides access to one or more resources. The session control system may provide support to the user from user login to user logout. The session control system may support or work with any software, hardware or products providing an access method. In some embodiments, the session control system 120 works with a virtualized environment 195.

The session control system 120 may include software, hardware or any combination of software and hardware to dynamically control the user's session and environment 108. A user via the user's session may access applications provided via any one of a plurality of access types 107. The session control system 120 may be considered a layer—logical, physical or otherwise—working on top of or otherwise in conjunction with any other software, systems or products and dynamically managing the user's session. Multiple applications and/or multiple access methods may be a part of a user's session controlled by the session control system 120. The session control system 120 provides a dynamic, flexible and stable user environment that roams with the user from computing device to computing device. By way of example and not inclusive, the session control system 120 provides any of the following functionalities: 1) session management to provide updates or maintenance tasks that are performed when a user requests an application or after logoff, 2) end users may select actions or task to fix problems with applications, 3) reduction of application conflicts, 4) centralized administration, 5) flexibility in configuring which uses have access to which applications, 6) support for roaming users, and 7) local caching to provide users access to centrally managed applications if working offline. Other embodiments and functionalities of the session control system 120 will be described in more detail below.

The session control system 120 may provide a user session and environment in which or during which a user accesses one or more application via any type and form of access type or method 107, including but not limited to generic or fat client access, installed application via an installer, virtualized environment with virtual layers, and/or a streamed application or environment. In one embodiment, the session control system 120 provides control and management of a user's session and environment, in which the user accesses an application via a desktop computing environment. In another embodiment, the session control system 120 provides control and management of a user's session and environment in which the user accesses applications that are dynamically installed or installed on the fly via an installation program, such as a Windows installer or any other type and form of installation program or script designed or constructed for installing an application on the operating system or environment of the computing device. In other embodiments, the session control system 120 provides control and management of a user's session and environment in which the user accesses any type and form of streaming application or environment. In some embodiments, the session control system 120 provides control and management of a user's session and environment in which the user accesses one or more applications via one or more layers of a virtualized environment.

In some embodiments, an application delivery system transmits to a client output data generated by execution of the application program on a server 106. In another embodiment, the server 106 transmits a plurality of application files comprising an application to allow or enabling the client 102 to execute the application program locally. In yet another embodiment, the server 106 may stream the application via the network 104 to the client 102. In this embodiment, a first plurality of files in a stream of files comprising the application may be stored and executed on the client 102 while the server 106 transmits a second plurality of files in the stream of files to the client. This process may be referred to as “application streaming.”

In one embodiment, an application may be virtualized so that the application does not need to be installed on the computing device to run on the computing device, such as via a virtualized environment 195. In some embodiments, a virtualized environment 195 includes virtual layers. An application is virtualized by placing or running the application in a virtual layer. In one embodiment, the virtualized environment includes a base layer in addition to a virtual layer. The base layer provides non-virtual files and settings for the file system and registry of the operating system or “real” layer of the computing device. For example, the base layer may include all the files and settings of the operating system. Different application or virtual layers and bases layers may be organized or arranged in a hierarchy. Depending on the orders of the layers in the hierarchy determines whether or not one layer sees files or settings of another layer.

The user's setting and environment 108 may include any information and data related to a user, such as a user's use of an application, desktop, operating system, virtualized environment, virtual layer, network, streamed application, or installation of an application, or any resources accessed via any of the above items. The user's setting and environment may be device and system agnostic such that these user setting and environment may be applied to any type of computing device the user is on and may roam from device to device with the user. In some embodiments, the user's setting and environment 108 includes a user profile. In one embodiment, the user profile 108 describes the configuration for a specific user, including setting for the user's environment and preferences. The user profile may include those settings and configuration options specific to the user, such as installed applications, desktop icons, and color options. In another embodiment, the user's setting and environment 108 includes shortcuts, favorites, icons, desktop arrangement, saved files, recovered files or recently used files of the user.

In some embodiments, the user profile includes the user's personalized settings for the software installed on the computer, including the operating system. In one embodiment, the user profile includes registry settings. In other embodiments, the user profile includes keys for a registry. In another embodiment, the user profiles comprises one or more documents of the users. In yet another embodiment, the user profiles includes browser-based or related data, such as favorites, cookies and history. In some embodiments, the user profile identifies one or more network drives. In one embodiment, the user profile identifies one or more shared drives. In other embodiments, the user profile identifies a printer. In still another embodiment, the user profile includes any start menu options or shortcuts. In some embodiments, the user profiles includes files and shortcuts present on the user's desktop. In other embodiments, the user profile includes data related to an application that the application stores to one or more directories of the user.

The user settings and environment 108, such as via a user profile, may identify data and information related to an application accessed via one access method or a plurality of access methods 107. In one embodiment, the user profile is for an operating system. In another embodiment, the user profile is for a streamed application or environment. In other embodiment, the user profile is for a virtualized environment or a virtual layer, or an applications accessed via the virtualized environment or layer. In some embodiments, the user profile is for a thin-client application. In one embodiment, the user profile is for an installed application on the client. In further embodiments, the user profile may include user settings related to a plurality of access types 107.

By way of example and in no way limiting, the session control system 120 may provide a user's session and environment 108 in conjunction with any of the access methods 107 provided via the products and versions of Altiris software virtualization solution manufactured by Altiris, Inc. of Lindon, Utah, now a part of Symantec Corporation of Cupertino, Calif., Microsoft Software Management System (SMS) manufactured by Microsoft Corporation of Redmond, Wash., any of the products of the Novell Zenworks Suite manufactured by Novell, Inc. of Waltham, Mass., any of the virtualization and streaming products manufactured by Citrix Systems, Inc. of Ft. Lauderdale, Fla., and any of the products and versions of VMware manufactured by VMware, Inc. of Palo Alto, Calif.

Referring now to FIG. 1B, an embodiment of a session control system 120 is depicted. In brief overview, a workstation or client 102 may access an application via a server 106. The client 102 includes a client agent 110 for managing and controlling a user's session and environment on the client 102. The client agent 110 may execute one or more session scripts 111 to control and manage a user's session and environment on the client. The client agent 110 may be in communication over a network 104 with an engine 112 on server 106. The engine 112 may be in communication with a database 114 and an active directory over a network 104′. The engine 112 collects and processes data from the database 114, which may include information on applications, users and actions to be executed. In some embodiments, the session control system 120 may include any versions of the Scense product manufactured by Scense B.V. of The Netherlands. In other embodiments, the session control system 120 may be incorporated in or comprise any version of the products of Altiris, Inc. (now a part of Symantec) as identified above.

In further detail, the client agent 110 may include software, hardware or any combination of software and hardware. In some embodiments, the client agent 110 includes an application, program, library, driver, process, service, task, thread or any type and form of executable instructions. In one embodiment, the client agent 110 operates in kernel-mode of the operating system of the client 102. In another embodiment, the client agent 110 operates in user-mode of the operating system. In some embodiments, the client agent 110 operates as a program on the task bar of a desktop environment.

The client agent 110 may operate at any level or layer of a network stack of a client 102. In one embodiment, the client agent 110 operates at the application layer of a network stack of the client 102. In another embodiment, the client agent 110 operates at the session layer of the network stack. In some embodiments, the client agent 110 operates at a presentation layer of the network stack. In yet another embodiment, the client agent 110 operates at a layer 4 or transport layer of the network stack. In still further embodiments, the client agent 110 operates below the transport layer, such as at the network layer of the network stack. In one embodiment, the client agent 110 comprises a network driver or shim. In some embodiments, the client agent 110 may intercept and forward communications from a server to the client 102. In other embodiments, the client agent 110 may receive and forward communication from the engine 112 to the client 102.

The client agent 110 may manage, control and provide a user's session and environment on the client 102 for any access method 107. In some embodiments, the client agent 110 communicates with the user. The client agent 110 may provide an interface identifying the applications or resources to which the user has access. In another embodiment, the client agent 110 provides a user interface to allow a user to manage the user's own session and profile. In other embodiments, the client agent 110 provides a user interface for a user to execute administrator-predefined tasks such as “Restore start menu shortcuts” or “Restore network connections.” In yet another embodiment, the client agent 110 provides a user interface or mechanism for a user to initiate or start an automatic re-installation or repair of any software, application or resource on the client 102.

The client agent 110 may receive information, data, instructions, scripts and/or programs from the engine 112 to construct, arrange, organize or provide a user session and environment 108 on the client 102. Upon detecting any event of the client 102 or of the user on the client 102, the client agent 110 may request information from the engine 112. In one embodiment, the client agent 110 upon detection of a user's logon request requests the user's profile from the engine 112. The client agent 110 may modify, configure, adapt, construct or otherwise cause the user's session and environment on the client 102 to correspond to or be in accordance with the user data and profile obtained via the engine 112.

The client agent 110 may dynamically construct or adapt the user's session and environment 108 on the client 102 via execution of one or more scripts 111. In some embodiments, the client agent 110 generates, creates or assembles the script based on information and data received from the engine 112. For example, the client agent 110 may include a scripter 111 for dynamically generating or assembling content of a script. In other embodiments, the client agent 110 receives the script from the engine 112. In yet another embodiment, the client agent 110 receives one or more scripts from another computing device, such as a server 106, on a network 104. In one embodiment, a script may be associated with an event, such as a session event.

The session control system 120 via the client agent 110 and/or engine 112 may use scripts to control and management a user's session and/or environment 108. The session control system 120 provides dynamic scripts 111 for a plurality of session events. The script content may be assembled real-time responsive to the session event. For example, the client agent 110 may detect a session event and responsive to the session event assemble and execute a script 111. The script content may depend on the user's group membership, the operating system, and global settings. For example, the script may depend on user information and data obtained via the engine 112 and/or database 114. In some cases, the script executed by the client agent is automatically tailored for each individual user. By way of example and in no manner limiting, the following are examples of scripts 111 used to dynamically control and manage a user's session and environment 108 via the session control system 120:
Session Control: This session control script may be executed repeatedly, every time after a predefined interval. The session control script may be used to execute repeating maintenance tasks.
LogOn: A Logon script is a dynamic script that may replace conventional logon scripts of the access type 107. The login script may only execute those tasks explicitly identified as necessary at logon. Depending on group membership(s) of a user, the logon script may carry out tasks such as the creation of shortcuts and the availability of applications.
Delayed: A delayed script is executed after an established waiting time or predetermined delay time. This enables an administrator to schedule tasks—e.g. inventories, maintenance and virus scanner updates—in the background, without disturbing the user.
LogOff: A logoff script may used to execute tasks—e.g. cleaning tasks—during user logoff or shutdown of the workstation.
Computer Script: This script may be considered a logon script for the computer, and takes executes computer based tasks during the session.
Application Launch: This script executes one or more actions when a user clicks an application (or shortcut) that has been used by this user before. The script includes actions to be executed, such as “attach network resource” and “start the application.”.
Application Install: This script may include the actions to be executed for installing an application. This script is executed when a user uses a predetermined application for the first time, or when the user chooses to re-install the application.
   The scripts 111 and any actions to be executed by the scripts, or content thereof, during different session events may be modified by an administrator using an administration tool referred to as the Explorer described in more detail below. The scripts may be written or created with any scripting language, including VBScript, JavaScript, perl, etc.

The engine 112 may comprise software, hardware or any combination of software and hardware. In some embodiments, the engine 112 includes an application, program, library, driver, process, service, task, thread or any type and form of executable instructions. In one embodiment, the engine 112 operates in kernel-mode of the operating system of a server 106 while, in another embodiment, the engine 112 operates in user-mode of the operating system. The engine 112 may use any type of protocol to communication with a client agent 110, such as proprietary protocol or an application protocol, such as HTTP. For example, the engine may comprise a web server communicating with the client agent via HTTP. In other embodiments, the engine 112 uses any type and form of request/response protocol to communicate with the client agent 110. The engine 112 may provide any type and form of application programming interface (API) for a client agent to communicate with the engine 112, such as an object oriented or object based API. In one embodiment, the engine 112 may use web services, XML or SOAP based interfaces to communicate with the client agent 110.

The engine 112 provides a point of access for dynamically constructing or providing a user's environment based on user profiles, settings and definitions stored in a central manner and independent of location and type of computing device of the user. The engine 112 may obtain and collect the user's information from one or more data sources, such as an Active Directory and/or database 114. The engine 112 may be designed and constructed to handle a plurality of client agents 110 and/or clients 102. The engine 112 may provide a plurality of client agents 110 access to one or more databases 114. The engine 112 may include any type and form of interface for communication with a database 114. In some embodiments, the engine 112 may store in the database 114 any user information from the user's session and environment 108 on the client 102.

As depicted in FIG. 1B, the engine 112 may communicate with or interface to an Active Directory. In one embodiment, the Active Directory is the directory service and structure supported by a Windows environment. The Active Directory provides tracking and location services for any object on a network. The Active Directory may include a database that holds information about component locations, users, groups, passwords, security, and other information. In some embodiments, the Active Directory provides the ability to build applications that give a single point of access to multiple directories in a network environment. The Active Directory stores information about resources on the network and provides a means of centrally organizing, managing, and controlling access to these resources.

Although the Active Directory is generally described in the form of Microsoft's implementation of an LDAP (Lightweight Directory Access Protocol) directory service, any type and form of directory service may be used in conjunction with the session control system 120 described herein. The Lightweight Directory Access Protocol, or LDAP is an application protocol for querying and modifying directory services, such as services running over a TCP/IP network 104. A directory is a set of objects with attributes organized in a logical and hierarchical manner. The directory service provides central authentication and authorization services for workstations and other computers. The directory service also allows administrators to assign policies, deploy software, and apply critical updates to an entire organization. The directory services stores information and settings relating to an organization in a central, organized, and accessible database.

The database 114, generally also referred to as data source, may comprise any type and form of data. In one embodiment, the database 114 comprises any type and form of relational database, non-relational database, object database, or object-oriented database. In some embodiments, the database 114 comprises any of the database products manufactured by Oracle of Redwood Shores, Calif. In another example, the database 114 comprises any of the versions of Microsoft SQL Server manufactured by Microsoft Corporation of Redmond, Wash. In one embodiment, the database 114 provides an Open Database Connectivity (ODBC) interface for accessing the database. In another embodiment, the database 114 comprises a server farm of databases. In some embodiments, the database 114 comprises a database cluster.

In other embodiments, the database 114 comprises a file, such as a CSV (comma separated) formatted file. In another embodiment, the database 114 comprises a file having fields or values delimited in any manner by using fixed length field or any predetermined field or value delimiters. The file may have a structure, format, and/or content readable and understandable by the session control system 120, or any portion thereof. In other embodiments, the database 114 includes an application, program, software, service, process or task providing access to data. The database 114 may provide any type and form of application programming interface (API), such as an XML, object, or web-service based interface for accessing or providing data. In another example, the database 114 comprises a network accessible web service interface providing access to data, such as via an ecommerce or web-site.

Referring now to FIG. 1C, another embodiment of the session control system 120 is depicted. In this embodiment, the session control system 120 provides dynamic session control and management for a user in a thin-client or server-based computing model. The client 102 may access one or more applications executing on a server 106. The server may display output of applications running on the server via a remote display protocol to the client 102. The client agent 110 may execute or operate on the server 106 and communicate with the engine 112 executing on the same server 106 or a different server 106′. The client agent 110 may work in conjunction with the engine 112 to assemble and execute one or more scripts 111 to dynamically control and deliver the user's session and environment 108 via the server 106.

In one embodiment, the server 106 may be a multi-user server running remote display protocol servers such as Microsoft Terminal Server from Microsoft Corporation or Citrix Presentation Server from Citrix Systems, Inc., which allow users to connect to the server 106 to run applications from the server 106 and have output from the running of the application display on the client 102. In some embodiments, the server 106 communicates to the client using a version of the Independent Computing Architecture (ICA) protocol from Citrix Systems, Inc. of Fort Lauderdale, Fla. In one embodiment, the session control system 120 dynamically controls and manages a user's session and environment 108 comprising an ICA session. In another embodiment, the server 106 communicates to the client using a version of a Remote Desktop Protocol (RDP) from Microsoft Corporation of Redmond, Wash. In other embodiments, the session control system 120 dynamically controls and manages a user's session and environment 108 comprising an RDP session.

In some embodiments, the engine 112 and/or database 114 may operate on the server 106 or on a server farm providing the one or more thin-client or server-based computing servers. In other embodiments, the engine 112 and/or database 114 may operate on a server or server farm separate from those servers or server farms deploying the thin-client or server-based computing systems.

Still referring to FIGS. 1B and 1C, the network 104 may be any type and/or form of network and may include any of the following: a point to point network, a broadcast network, a wide area network, a local area network, a telecommunications network, a data communication network, a computer network, an ATM (Asynchronous Transfer Mode) network, a SONET (Synchronous Optical Network) network, a SDH (Synchronous Digital Hierarchy) network, a wireless network and a wireline network. In some embodiments, the network 104 may comprise a wireless link, such as an infrared channel or satellite band. The topology of the network 104 may be a bus, star, or ring network topology. The network 104 and network topology may be of any such network or network topology as known to those ordinarily skilled in the art capable of supporting the operations described herein.

Although FIGS. 1B and 1C show a network 104 and 104′ (generally referred to as network(s) 104) any portion of the session control system 120 may reside on other networks 104′, 104″. For example, the client agent 110 on a first network 104, the engine 112 and database 114 on a second network 104′. The networks 104, 104′ can be the same type of network or different types of networks. The network 104 may be a local-area network (LAN), such as a company Intranet, a metropolitan area network (MAN), or a wide area network (WAN), such as the Internet or the World Wide Web. The networks 104 may be a private or public network. In one embodiment, network 104′ or network 104″ may be a private network and network 104 may be a public network. In some embodiments, network 104 may be a private network and network 104 a public network. In another embodiment, networks 104, 104′ may be private networks.

Referring now to FIG. 1E, an embodiment of a method of the session control system 120 handling sessions and the user environment is depicted in view of FIGS. 1C and 1D. Please note that steps 180-190 in FIG. 1E correspond to and are identified by steps 0-5 in FIGS. 1C and 1D. In brief overview, at step 180 (step 0), the user logs on to the client 102. At step 182 (step 1), the client agent 110 detects this activity and requests logon data from the engine 112. At step 184, (step 2), the engine 112 queries the Active Directory for group membership information of the user, e.g., to determine the group to which the user is a member. At step 186 (step 3), the engine 112 queries the database 114 for logon settings of the user belonging to the group. At step 188 (step 4), the engine 112 received the requested data from the database 114. The requested data may include the personal settings of the user and the applications the user access to being a member of the determined group. This information of the requested data is based on central user definitions in the database 114, which are independent of location and the type of computing device. This information is forwarded to the client agent 110 to be applied to user' settings and environment on the client at step 190 (step 5). The individual settings, applications, shortcuts etc. (the user profile) is configured on the workstation, based on communication with the client agent. In case of a thin client, the user profile may be copied to a terminal server 106, and applications run from this server.

### Computing Device

The client 102, server 106, and session control system 120, or any components thereof may be deployed as and/or executed on any type and form of computing device 100, such as a computer, network device or appliance capable of communicating on any type and form of network and performing the operations described herein. FIGS. 1E and 1F depict block diagrams of a computing device 100 useful for practicing an embodiment of the data processing system 120.

As shown in FIGS. 1E and 1F, each computing device 100 includes a central processing unit 101, and a main memory unit 122. As shown in FIG. 1E, a computing device 100 may include a visual display device 124, a keyboard 126 and/or a pointing device 127, such as a mouse. Each computing device 100 may also include additional optional elements, such as one or more input/output devices 130a-130b (generally referred to using reference numeral 130), and a cache memory 140 in communication with the central processing unit 101.

The central processing unit 101 is any logic circuitry that responds to and processes instructions fetched from the main memory unit 122. In many embodiments, the central processing unit is provided by a microprocessor unit, such as: those manufactured by Intel Corporation of Mountain View, Calif.; those manufactured by Motorola Corporation of Schaumburg, Ill.; those manufactured by Transmeta Corporation of Santa Clara, Calif.; the RS/6000 processor, those manufactured by International Business Machines of White Plains, N.Y.; or those manufactured by Advanced Micro Devices of Sunnyvale, Calif. The computing device 100 may be based on any of these processors, or any other processor capable of operating as described herein.

Main memory unit 122 may be one or more memory chips capable of storing data and allowing any storage location to be directly accessed by the microprocessor 101, such as Static random access memory (SRAM), Burst SRAM or SynchBurst SRAM (BSRAM), Dynamic random access memory (DRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Enhanced DRAM (EDRAM), synchronous DRAM (SDRAM), JEDEC SRAM, PC100 SDRAM, Double Data Rate SDRAM (DDR SDRAM), Enhanced SDRAM (ESDRAM), SyncLink DRAM (SLDRAM), Direct Rambus DRAM (DRDRAM), or Ferroelectric RAM (FRAM). The main memory 122 may be based on any of the above described memory chips, or any other available memory chips capable of operating as described herein. In the embodiment shown in FIG. 1E, the processor 101 communicates with main memory 122 via a system bus 150 (described in more detail below). FIG. 1E depicts an embodiment of a computing device 100 in which the processor communicates directly with main memory 122 via a memory port 103. For example, in FIG. 1F the main memory 122 may be DRDRAM.

FIG. 1F depicts an embodiment in which the main processor 101 communicates directly with cache memory 140 via a secondary bus, sometimes referred to as a backside bus. In other embodiments, the main processor 101 communicates with cache memory 140 using the system bus 150. Cache memory 140 typically has a faster response time than main memory 122 and is typically provided by SRAM, BSRAM, or EDRAM. In the embodiment shown in FIG. 1E, the processor 101 communicates with various I/O devices 130 via a local system bus 150. Various busses may be used to connect the central processing unit 101 to any of the I/O devices 130, including a VESA VL bus, an ISA bus, an EISA bus, a MicroChannel Architecture (MCA) bus, a PCI bus, a PCI-X bus, a PCI-Express bus, or a NuBus. For embodiments in which the I/O device is a video display 124, the processor 101 may use an Advanced Graphics Port (AGP) to communicate with the display 124. FIG. 1F depicts an embodiment of a computer 100 in which the main processor 101 communicates directly with I/O device 130 via HyperTransport, Rapid I/O, or InfiniBand. FIG. 1F also depicts an embodiment in which local busses and direct communication are mixed: the processor 101 communicates with I/O device 130 using a local interconnect bus while communicating with I/O device 130 directly.

The computing device 100 may support any suitable installation device 116, such as a floppy disk drive for receiving floppy disks such as 3.5-inch, 5.25-inch disks or ZIP disks, a CDROM drive, a CD-R/RW drive, a DVD-ROM drive, tape drives of various formats, USB device, hard-drive or any other device suitable for installing software and programs such as any data processing system 120, or portion thereof. The computing device 100 may further comprise a storage device 128, such as one or more hard disk drives or redundant arrays of independent disks, for storing an operating system and other related software, and for storing application software programs such as any program related to the data processing system 120. Optionally, any of the installation devices 116 could also be used as the storage device 128. Additionally, the operating system and the software can be run from a bootable medium, for example, a bootable CD, such as KNOPPIX®, a bootable CD for GNU/Linux that is available as a GNU/Linux distribution from knoppix.net.

Furthermore, the computing device 100 may include a network interface 118 to interface to a Local Area Network (LAN), Wide Area Network (WAN) or the Internet through a variety of connections including, but not limited to, standard telephone lines, LAN or WAN links (e.g., 802.11, T1, T3, 56 kb, X.25), broadband connections (e.g., ISDN, Frame Relay, ATM), wireless connections, or some combination of any or all of the above. The network interface 118 may comprise a built-in network adapter, network interface card, PCMCIA network card, card bus network adapter, wireless network adapter, USB network adapter, modem or any other device suitable for interfacing the computing device 100 to any type of network capable of communication and performing the operations described herein.

A wide variety of I/O devices 130a-130n may be present in the computing device 100. Input devices include keyboards, mice, trackpads, trackballs, microphones, and drawing tablets. Output devices include video displays, speakers, inkjet printers, laser printers, and dye-sublimation printers. The I/O devices 130 may be controlled by an I/O controller 123 as shown in FIG. 1E. The I/O controller may control one or more I/O devices such as a keyboard 126 and a pointing device 127, e.g., a mouse or optical pen. Furthermore, an I/O device may also provide storage 128 and/or an installation medium 116 for the computing device 100. In still other embodiments, the computing device 100 may provide USB connections to receive handheld USB storage devices such as the USB Flash Drive line of devices manufactured by Twintech Industry, Inc. of Los Alamitos, Calif.

In some embodiments, the computing device 100 may comprise or be connected to multiple display devices 124a-124n, which each may be of the same or different type and/or form. As such, any of the I/O devices 130a-130n and/or the I/O controller 123 may comprise any type and/or form of suitable hardware, software, or combination of hardware and software to support, enable or provide for the connection and use of multiple display devices 124a-124n by the computing device 100. For example, the computing device 100 may include any type and/or form of video adapter, video card, driver, and/or library to interface, communicate, connect or otherwise use the display devices 124a-124n. In one embodiment, a video adapter may comprise multiple connectors to interface to multiple display devices 124a-124n. In other embodiments, the computing device 100 may include multiple video adapters, with each video adapter connected to one or more of the display devices 124a-124n. In some embodiments, any portion of the operating system of the computing device 100 may be configured for using multiple displays 124a-124n. In other embodiments, one or more of the display devices 124a-124n may be provided by one or more other computing devices, such as computing devices 100a and 100b connected to the computing device 100, for example, via a network. These embodiments may include any type of software designed and constructed to use another computer's display device as a second display device 124a for the computing device 100. One ordinarily skilled in the art will recognize and appreciate the various ways and embodiments that a computing device 100 may be configured to have multiple display devices 124a-124n.

In further embodiments, an I/O device 130 may be a bridge 170 between the system bus 150 and an external communication bus, such as a USB bus, an Apple Desktop Bus, an RS-232 serial connection, a SCSI bus, a FireWire bus, a FireWire 800 bus, an Ethernet bus, an AppleTalk bus, a Gigabit Ethernet bus, an Asynchronous Transfer Mode bus, a HIPPI bus, a Super HIPPI bus, a SerialPlus bus, a SCI/LAMP bus, a FibreChannel bus, or a Serial Attached small computer system interface bus.

A computing device 100 of the sort depicted in FIGS. 1E and 1F typically operate under the control of operating systems, which control scheduling of tasks and access to system resources. The computing device 100 can be running any operating system such as any of the versions of the Microsoft® Windows operating systems, the different releases of the Unix and Linux operating systems, any version of the Mac OS® for Macintosh computers, any embedded operating system, any real-time operating system, any open source operating system, any proprietary operating system, any operating systems for mobile computing devices, or any other operating system capable of running on the computing device and performing the operations described herein. Typical operating systems include: WINDOWS 3.x, WINDOWS 95, WINDOWS 98, WINDOWS 2000, WINDOWS NT 3.51, WINDOWS NT 4.0, WINDOWS CE, and WINDOWS XP, all of which are manufactured by Microsoft Corporation of Redmond, Wash.; MacOS, manufactured by Apple Computer of Cupertino, Calif.; OS/2, manufactured by International Business Machines of Armonk, N.Y.; and Linux, a freely-available operating system distributed by Caldera Corp. of Salt Lake City, Utah, or any type and/or form of a Unix operating system, among others.

In other embodiments, the computing device 100 may have different processors, operating systems, and input devices consistent with the device. For example, in one embodiment the computer 100 is a Treo 180, 270, 1060, 600 or 650 smart phone manufactured by Palm, Inc. In this embodiment, the Treo smart phone is operated under the control of the PalmOS operating system and includes a stylus input device as well as a five-way navigator device. Moreover, the computing device 100 can be any workstation, desktop computer, laptop or notebook computer, server, handheld computer, mobile telephone, any other computer, or other form of computing or telecommunications device that is capable of communication and that has sufficient processor power and memory capacity to perform the operations described herein.

### B. Session Control Database and Central Administration

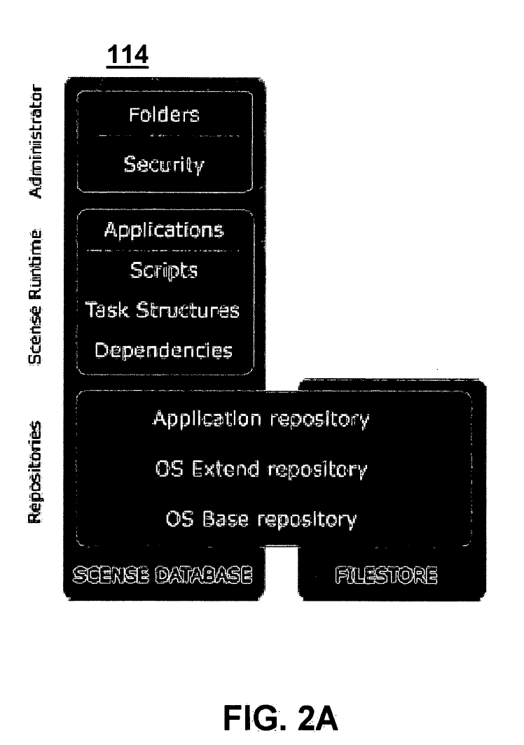

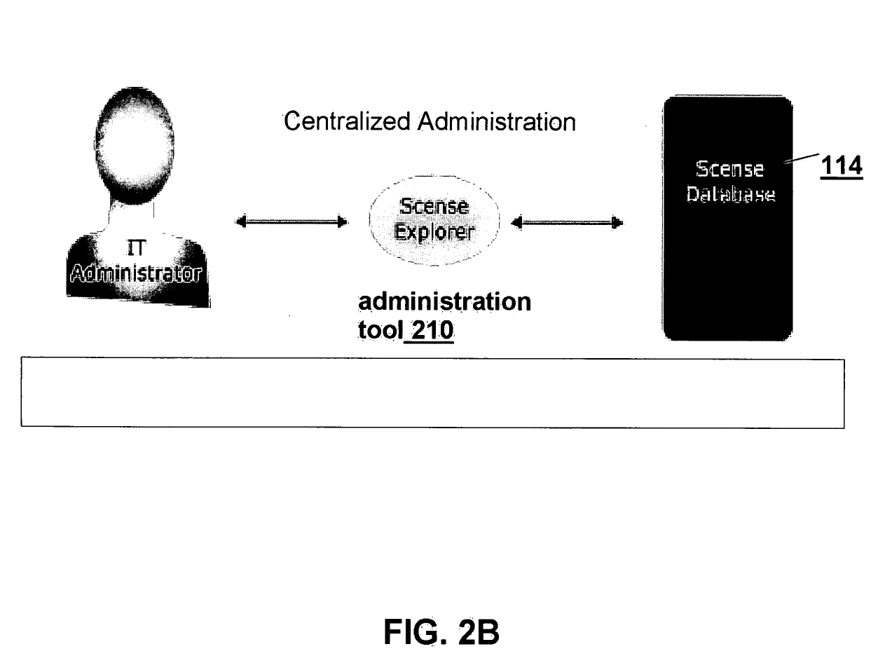

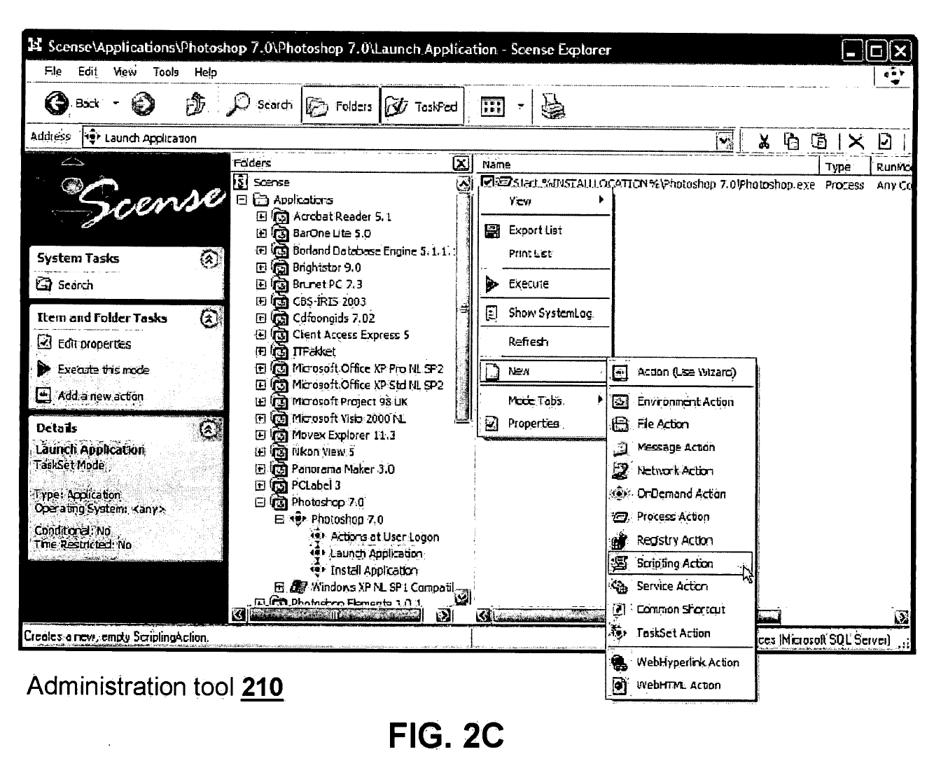

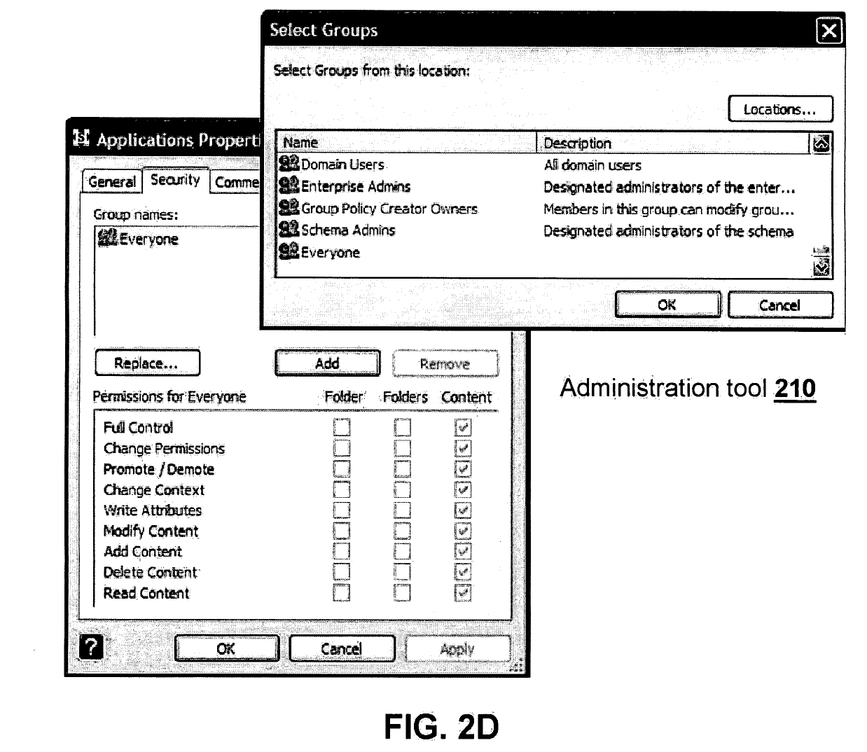

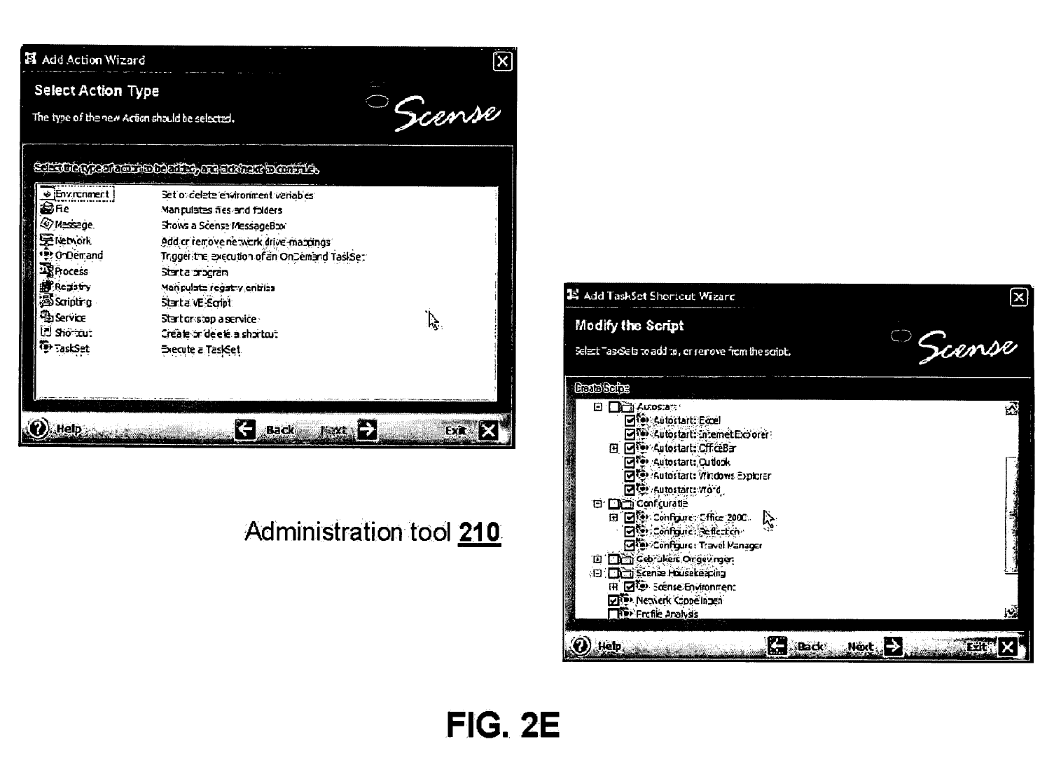

Referring now to FIG. 2A, an embodiment of the database 114 for centrally storing a user's session and environment 108 is depicted. The database 114 comprises several types of information. As depicted in one embodiment, the database 114 may comprise a section having administrator information, runtime information and repository information. The runtime information may include any type of information need during runtime, such as application definitions, scripts 111, task structures and any dependencies. The repository section of the database 114 includes information on what files are used by what applications. The repository provides a connection or association between files and applications. Data of the database 114 maybe organized and protected via the administration portion of the database. Via the central storage of application and user session and environment data via the database 114, administrators may centrally manage all scripts and tasks. For example, users can easily be added to or removed from user groups, and applications and updates can be added quickly.

The runtime portion of the database 114 includes information and data for dynamically controlling and managing a user's session and environment on the client 102. The database 114 may include scripts 111, such as template scripts that may be modified, adapted or assembled for execution for a specific user. The runtime portion of the database may identify a plurality of applications that may be accessed by any one or more users. The database 114 may include any type and form of specification or definitions for each of these applications, including an application identifier, version number, operating system support, computing device support, etc. The runtime portion may also include any structures, such as data, objects, etc. to support task execution by the engine 112 and/or the client agent 110. The runtime portion may also include any data and information the applications, scripts or task structures may depend on including any information related to the access method 107.

The administration portion of the database 114 may include any authentication, authorization and/or auditing information for controlling and managing access to the runtime portions of the database and/or the repository portions of the database by a user, client or a server. The database 114 may also include and/or store any information obtained from the Active Directory regarding users, groups, or any other information provided by the directory service. This administrative portion of the database may identify those users with administrative privileges or rights to modify, configure, or change any portion of the database. In some embodiments, a first user may have access rights to a first portion of the database while a second user has access rights to a second portion of the database In one embodiment, the administrative portion identifies the user's rights to access—install, run or otherwise, any of the applications. In some embodiments, the administrative portion identifies the user's rights based on the access method 107.

Although the database 114 is generally described as a database with multiple portions, the database 114 may include multiple databases on one or more servers. In some embodiments, the administration portion may be on a first database, the runtime portion on a second database, and the repositories on a third database. In other embodiments, multiple databases may have portions of each of the administration, runtime and repository data. In one embodiment, one or more repositories or portions thereof may be stored on a server.

Referring to FIG. 2B, an embodiment of a centralized administration tool 210 of the session control system 120 is depicted. In one embodiment, the session control system 120 is a client/server system. As such, in some embodiments, the client agent 110 on the workstation obtains its data from a server 106. The server may include a database 114 in which the necessary data is stored, such as what user groups have access to which applications and what actions have to be executed at different moments. In other embodiments, the session control system 120 is considered a multi-tier system in which the client agent 110 (a first tier) access data via the engine 112 (a second tier) which obtains the data from a database 114 (a third tier). The data used by the client agent 110 and/or engine 112 is stored in the database 114. The administration tool 210 may be used to create, modify, edit or otherwise provide any of the data in the database 114. An administrator may change the configuration of data in the database 114 to make changes to be behavior and use of the session control system 120.

The administration tool 210, sometimes referred to as Explorer, may comprise any type and form of user interface. In one embodiment, the administration tool 210 comprises a graphical user interface. In another embodiment, the administration tool 210 comprises a command line interface. In some embodiments, the administration tool 210 provides a web-based browser interface. In one embodiment, the administration tool 210 provides an appearance and behavior (“look and feel”) similar to the Windows Explorer manufactured by the Microsoft Corporation, such as the user interface depicted in FIG. 2C.

The administration tool 210 provides a user interface to specify, configure and manage applications and any underlying structures. Via the administration tool 210, the task structures may be managed to provide very detailed control over applications and the way the applications are presented to the user. The administration tool 210 may be used to create or provide a script 111 for a session event. Actions to be executed during the different session events may be modified by the administrator. As illustrated in FIG. 2D, an administration can add and configure an action based on the launch of an application. In this illustration, the user is selecting a new script action to take upon launching of the application. As illustrated by the user interface in FIG. 2D, the administrator may select from a plurality of actions to take: 1) environment action, 2) file action, 3) message action, 4) network action, 5) OnDemand Action, 6) process action, 7) registry action, 8) scripting action, 9) service action, 10) Common Shortcut action, 11) TaskSet Action, 12) Web Hyperlink Action, and 12) Web HTML Action. The administrator may also use an action wizard to create and specify actions on any event. These actions may be triggered by or based on any event, such as a logon, logoff, launch of an application or installation of an application. The administration tool 210 enables the administrator to manage the user session in detail. If a predefined action does not offer sufficient flexibility to perform a desired or requested task, the administration may use a scripting-action to create a custom script 111 using any type and form of scripting language, such as VBscript or Java Script.

Referring now to FIG. 2D, access control to objects and data via the session control system 120 may be protected by means of access control lists. With the example user interface of the administration tool 210 in FIG. 2D, an administrator may configure access to any objects or data to different users. The administrator may delegate management tasks to other users while maintaining security. Via the administration tool 210, a user may provide access control to any data in the database 114. In some embodiments, the administrator has multiple operating levels, such as novice, advanced or expert level of users. For example, the novice level of operation may be used by less experiences operators to build task or action sets via the graphical user interface. At the novice level, the administration tool 210 may hide or prevent access to certain actions, such as those accessed by an advanced or expert level operator. In another example, the advanced operator may be able to view all actions and specify tasks in detail, but may not be able to change all the settings available via the tool 210. In a further example, the expert operator may be fully authorized to change all settings, including system parameters, etc.

Operators may be guided by a wizard for implementation of tasks, such as complex tasks An example embodiment of a wizard is depicted in FIG. 2E. The administration tool 210 may include a wizard to guide an administrator or operator through the configuration of any actions or tasks available via the session control system 120, such as via one or more user interface screens. For example, in a first user interface of the wizard of the administration tool 210, a user may select a type of action to configure. In a second user interface of the wizard, the user may modify a script based on the selection of the first user interface.

### C. Adaptive Installation

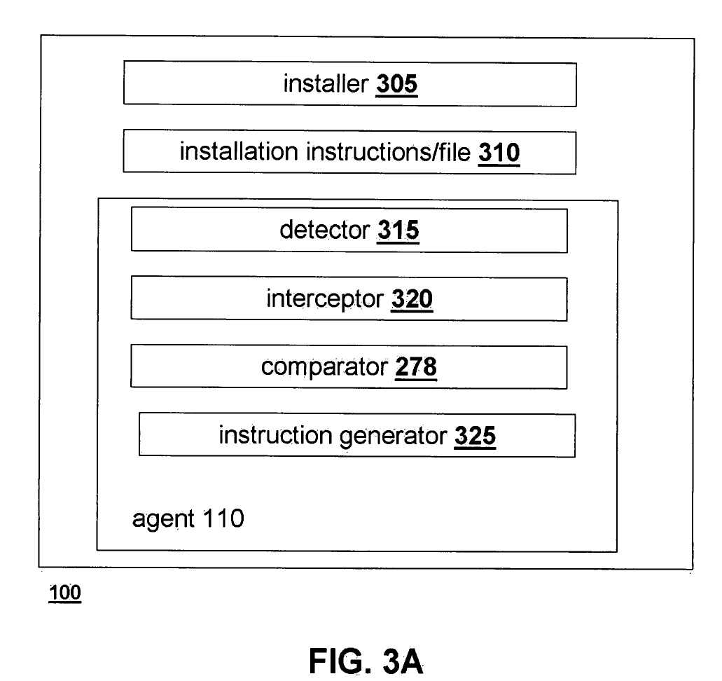

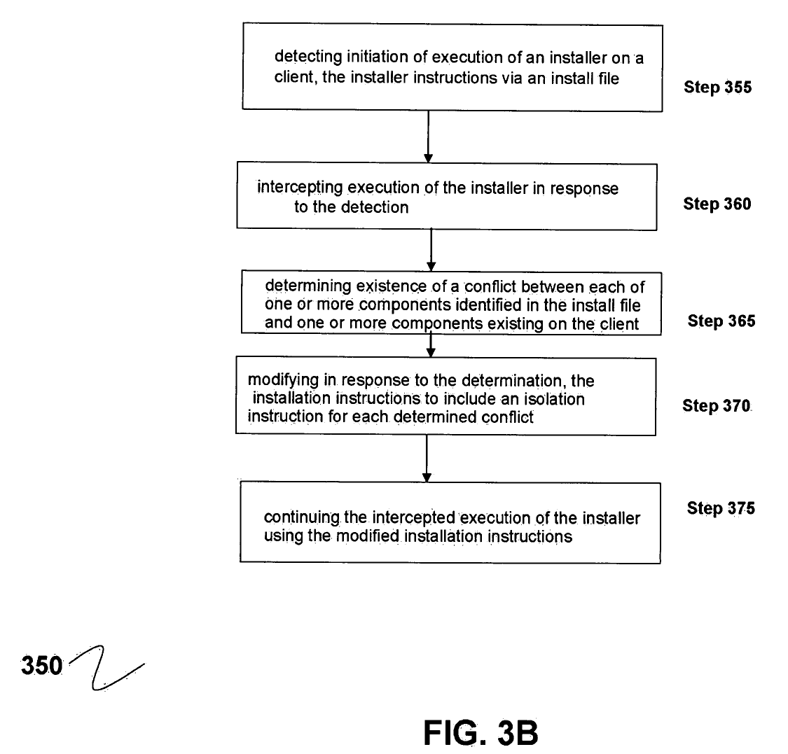

Referring now to FIGS. 3A and 3B, systems and methods for providing an adaptive installation technique are depicted. This adaptive technique provides a solution to avoid or prevent conflicts and incompatibilities between applications installed on a computer. The client agent checks at the time of installation the files of the application to be installed with the files on the computer on which the application will be installed. In this manner, actual conflicts that would occur on the computer at the time of installation are resolved at the time of but prior to completion of the installation process. Furthermore, this adaptive technique is performed in a manner transparent to the installer and the user of the client. In some embodiments, the adaptive technique uses or leverages the conflict isolation mechanisms of the installer to resolve the conflicts.

In performing this adaptive installation technique, the agent 110 intercepts and alters the installation process. For example, upon detecting an installer program has started, such as a Windows Installer, the agent intercepts the process and starts an analysis. The agent 110 may check all the files to be installed against the existing components on the computer where the installation process was started. If the agent determines there is a component of the installation that conflicts with an existing component on the computer, the agent 110 modifies installation instructions of the installer to include installer instructions to isolate the conflict. By using the installer program's instructions, the agent preserves any of the behavior and functionality of the installer for completing the installation and for performing any other functionality, such as auto-repair, uninstall, etc. After the agent has finished examining the components of the install to the components on the computer, the agent allows the installation to continue with the modified installation instructions.

Referring to FIG. 3A, an embodiment of a computing device with a client agent 110 for performing the adaptive installation technique is depicted. In brief overview, the computing device 100 or workstation may include an installer program 305 for installing an application. The installer program 305 may perform an installation based on instructions from an installation file 310. The client agent 110 may include a detector 315, interceptor 320, a comparator 278 and an instruction generator 325. The detector 315 may detect the start of an installation process on the device 100. The interceptor 320 may intercept the installation process responsive to the detector. The comparator 278 may determine any conflicts of incompatibilities between the files to be installed by the installer and any files on the computing device 100. Responsive to any conflicts or issues determined by the comparator 278, the instruction generator 325 may generate one or more instructions to isolate or prevent the conflicts by the installer 305. The agent 110 may modify the installation instructions of the installer to use these generated instructions. Upon completion of comparing by the comparator, the agent 110 or interceptor 320 may continue the intercepted installation to complete the installation of the application in accordance with the modified instructions.

The installer 305 may include any type and form of application, program, script, process, service, task or set of executable instructions for installing any application, program, library, driver, packages, objects, data or files on a computing device 100. The installer 305 may be designed, constructed or adapted to execute or install files for a type of operating system of the computing device. In one embodiment, the installer 305 may be designed, constructed or adapted to execute or install files for a fat client or client based application. In other embodiments, the installer 305 may be designed, constructed or adapted to execute or install files for any virtualized environment 195. In another embodiment, the installer 305 may be designed, constructed or adapted to execute or install files for a streaming application. In another embodiment, the installer 305 is an installation script of the session control system 120, such as one provided by Scense, Inc. of the Netherlands.

In one embodiment, the installer 305 includes any of the Windows Installer programs manufactured by the Microsoft Corporation. In some embodiments, the installer 305 is a part of or incorporated in any of the operating systems manufactured by the Microsoft Corporation. In yet another embodiment, the installer 305 includes any application, program or tool for providing a Microsoft Installation Files installation package referred to as MSI, which is the format used by the Windows Installer. For example, any of the following companies provide installers 305 for Windows operating system or for the MSI format: such as InstallShield and InstallAnywhere products manufactured by the Macrovision Corporation of Santa Clara, Calif., any of the Wise installation products provided by Altiris and Symantec, any of the versions of the SetupBuilder product manufactured by Lindersoft and any of the installation products manufactured by the ScriptLogic Corporation of Boca Raton, Fla. In other embodiments, the installer 305 may comprise any type and form of XML tool, such as WiX manufactured by the Microsoft Corporation to generate installer packages from an XML document. In further embodiments, the installer 305 may include any type and form of cross-platform installer.

The installer 305 may be adapted, designed and constructed to perform any type and form of installation with or without user interaction. In one embodiment, the installer 305 performs a manual installation or installer assisted installation. For example, the installer 305 may require manual user operations in addition to installer performed tasks. In another embodiment, the installer 305 performs a silent installation in that the installer does not display messages or windows during the installation process. In yet another embodiment, the installer 305 performs an unattended installation in which user interaction is not required during the progress of the installation, except for in some embodiments to initiate the launch of the installation process. In other embodiments, the installer 305 may perform self installation in which the installation is an unattended installation without the need of a user to initial launch of the process. For example, the installer 305 may be launched by another program, service, process or task, such as a driver. In yet further embodiments, the installer 305 may perform what is referred to as a headless installation in which a monitor or display is not required or used for the installation process.

The installer 305 may use any form of installation instructions or install file 315 to direct, control or dictate the installation process. The installation information 315 may be in any form such as a file, package, database or object. In some embodiments, the installation file 315 includes an MSI package or set of install instructions for a Windows Installer compatible installer. In view of the embodiment of the MSI package or Windows Installer, the installation information or install file 315 is packaged into an installation package comprising loosely relational databases structured as OLE structured storage files. Although generally described in the format of an MSI packager or Windows installer instructions, the installation instructions 315 may be in any format suitable for installation in accordance with the operations described herein.

In some embodiments, the installer 305 and installation instructions 310 are part of the same file or package. In other embodiments, the installer 305 and installation instructions 310 are separate files or packages. In one embodiment, the installer 305 obtains the installation instructions 310 from storage. In yet another embodiment, the installer 305 obtains the install file from another computing device or via the network 104. In some embodiments, the installer 305 generates or creates the installation instructions dynamically or on the fly. In yet another embodiment, the installer 305 obtains the instructions via the engine 112 and/or database 114.

The installer 305 may provide and/or the installation instructions 310 may include any type and form of installation instructions to isolate, avoid or prevent conflicts between components or files of the installation and components or files existing on the computer 100. In view of the embodiments of a Windows Installer 305, the installer 305 may include a plurality of methods for isolating conflicts. An isolation instruction may provide a directive, command or instruction to inform the installer 305 or application being installed where to find components, files or data for the application. In some embodiments, the isolation instruction identifies to the installer or application the location of a first component of a plurality of the same components installed on the computing device. In other embodiments, the isolation instruction identifies to the installer or application the version of a component of multiple versions of components installed on the computing device. In yet another embodiment, the isolation instruction identifies to the installer or application the registry key or setting to use to locate a component to be used by the installer or the application.

In one embodiment, the installer 305 and/or install instructions 310 uses a local isolation technique. In this embodiment, the installer 305 and/or install instructions makes file or directory entries with a .local extension to avoid conflicts. If a folder or file exists on the target computer with the same name as the file or folder to be installed, the installer and/or install instructions creates files or directory entries with a .local extension for the target application. The target application may look first for files and/or folders with .local extensions even if the registry settings indicates a different file or folder for a component of the application. In another embodiment, the installer 305 and/or installation instructions 310 uses a .NET isolation technique. This type of isolation makes use of a “manifest” file. In some embodiments, the manifest file has the same name as the application executable, and suffixed with ‘.manifest’ or other identifying extension. In one embodiment, the manifest file includes an XML structure or other markup language described or identifies the components to be pre-loaded for the application and from which location. This isolation technique also effectively resolves application component conflicts.

The detector 315 may comprise software, hardware or any combination of software and hardware. The detector 315 may comprises an application, program, script, process, service, task, thread or any type and form of executable instructions. The detector 315 may include logic, functions or operations to detect or otherwise determine the initiation or start of execution of an installation process by the installer 305. The detector 315 may determine if any one or more installers 305 start to execute on the computing device. In one embodiment, the detector 315 monitors processes running on the computing device to determine that a predetermined process or process name is executing. In some embodiments, the detector 315 includes a hook or filter for detecting any type and form of application program interface (API) call of the operating system related to installation or the installer. In another embodiment, the detector 315 provides a filter or monitors files and directories on the storage of the computing device for any instructions, command or directives to write a new file or folder to the storage, such as an install folder. In yet a further embodiment, the agent 110 informs the detector or the agent itself starts or initiates the installer 305.

The interceptor 320 may comprise software, hardware or any combination of software and hardware. The interceptor 320 may comprise an application, program, script, process, service, task, thread or any type and form of executable instructions. The interceptor 320 may include logic, functions or operations to suspend, pause or temporarily stop the execution of an installation process by the installer 305 or the installer 305 itself. The interceptor 320 may be responsive to the detector 305. The interceptor 320 may receive an event of detection by the detector 315 as well as information on the installer 305. In some embodiments, the interceptor 320 hooks the installer process 305 via any type and form of API or system function. Once hooked, the installer 305 may control and manage the state of execution of the installer process. In other embodiments, the interceptor 320 non-intrusively suspends or pauses the execution of the installer via any manipulation of data and blocks of memory of the computing device used for the installer. In another embodiment, the interceptor 320 non-intrusively suspends or pauses the execution of the installer via manipulation of instructions to or control of the processor. In other embodiments, the interceptor 320 may continue, resume or restart the installer 305 or installation process.

The comparator 278 as described above in FIG. 2A may include any logic, function or operations for comparing files of an application from one source to files located in another source. The comparator 278 may detect or determine any inconsistencies, conflicts, incompatibilities or any issue that may occur from the installation and the current environment or installed applications of the computer 100. In the case of the embodiment described in conjunction with FIG. 3A, the comparator 278 compares any of the files or components identified via the installation instructions 310 with any of the files or components existing or stored on the computing device 100 on which the installation process is being executed. The comparator 278 may identify a conflict between a file identified via the instructions 310 and a file stored on the computing device. The comparator 278 may identify a conflict between an install instruction identified via the instructions 310 and a file of the computing device. The comparator 278 may identify a conflict between an install instruction identified via the instructions 310 and one or more settings of the operating system. The comparator 278 may identify a conflict between an install instruction identified via the instructions 310 and any portion of the environment of the computing device.

The instruction generator 325 may comprise software, hardware or any combination of software and hardware. The instruction generator 325 may comprise an application, program, script, process, service, task, thread or any type and form of executable instructions. The instruction generator 325 may include logic, functions or operations to create, generate or provide any type and form of instructions for the installer 305. In some embodiments, the instruction generator 325 generates or provides an instruction to isolate any conflict or incompatibilities detected by the comparator 278. The instruction generator 325 may generate or provide isolation instructions in a format or form suitable for the installer 305. In one embodiment, the instruction generator 325 generates instructions in the format accessible or understood by the currently executed installer 305 or otherwise in the same format or form as the install instructions 310 used by the installer 305. The instruction generator 325 generates an isolation instruction using any isolation technique supported by the installer. In some embodiments, the instruction generator 325 stores the isolation instructions in memory. In other embodiments, the instruction generator 325 stores the isolation instructions to storage, such as an installation file 310.

The instruction generator 325 may generate isolation instructions responsive to the comparator 278. Each time the comparator identifies or detects a conflict or incompatibility, the instruction generator 325 may generate or provide a corresponding isolation instruction. In another embodiment, the instruction generator 325 may generate isolation instructions to corresponding detections of the comparator 278 in a batch mode. For example, the instruction generator 325 may generate instructions for a predetermined number of conflicts or detections. In another example, the instruction generator 325 may generate instructions upon the comparator 278 completing analyzing or comparing each of the install instructions 310. In some embodiments, the instruction generator 325 may insert or place the isolation instruction in a suitable location in a listing of instructions 310 in memory or storage. In other embodiments, the instruction generator 325 may insert a set of one or more isolation instructions at the start or end of the installation instructions 310 in memory or in file. In another embodiment, the instructions generator 325 may insert or place the one or more isolation instructions in the next set of instructions to be executed by the installer upon resuming or continuing execution.

The instruction generator 325 may use the same type of isolation technique or a plurality of isolation techniques. In some embodiments, the instruction generator 325 generates a manifest file or any entries in a manifest file. In other embodiments, the instruction generator 325 generates or provides a pointer or directive to a pre-existing manifest file, such as a predetermined isolation manifest template. In other embodiments, the instruction generator 324 generates an instruction to delete a file, folder or component. In some embodiments, the instruction generator 324 generates an instruction to move a file, folder or component to another location. In another embodiment, the instruction generator 324 generates an instruction to rename a file, folder or component. In yet one embodiment, the instruction generator 324 generates an instruction to overwrite a file, folder or component.

In one embodiment, the instruction generator 325 generates an isolation instruction using a first isolation technique for a first conflict. In another embodiment, the instruction generator 325 generates another isolation instruction using a second isolation technique for a second conflict. In some embodiments, the instruction generator 325 generates an isolation instruction based on the type of conflict or detection of the comparator. In other embodiments, the instruction generator 325 is configurable to use a predetermined isolation technique and in further embodiments, configured to use one of a plurality of predetermined isolation techniques based on the conflict or incompatibility.

Although the detector 315, interceptor 320, comparator 278 and instruction generator 325 are shown as separate elements or components of the agent 110 in FIG. 3A, any of these elements may be combined into one or more elements. In some embodiments, the client agent 110 includes the logic, operations and functionality of each of these elements in a single component. Furthermore, although the detector 315, interceptor 320, comparator 278 and instruction generator 325 are shown as existing within the agent 110 in FIG. 3A, any of these elements may be reside or execute outside the agent as separate executables.

Referring now to FIG. 3B, an embodiment of steps of a method for practicing the adaptive installation technique is depicted. In brief overview of method 350, at step 355, the agent 110 detects initiation of execution of an installer on a client 102. The installer 305 may obtain installation instructions from an install file 310. At step 360, the agent 110 intercepts execution of the installer in response to the detection. At step 365, the agent determines existence of any conflicts between each of the one or more components identified by the installation instructions and one or more components existing on the client. At step 370, the agent in response to this determination modifies the installation instructions to include an isolation instruction for each determined conflict. Upon completion of the determination of possible conflicts from the installation process, at step 375, the agent continues the intercepted execution of the installer using the modified installation instructions.

In further detail, at step 355, the detector 315 may detect the initiation or start of execution of an installer program or installation process. In one embodiment, the detector 315 detects the execution of a Windows Installer program. In another embodiment, the detector 315 detects the execution of an MSI compatible installation program 305. In some embodiments, the detector 315 detects the execution of a process of a predetermined installer 305. In other embodiments, the agent 110 initiates the installation process and thus detects the installer's initiation. In yet further embodiments, the agent 110 or detector 315 determines any activity of the installer has occurred or started to occur, such as downloading of files, storing of files, creating of directories or folders, querying data from or storing data to a registry, etc. In some embodiments, the agent 110 or detector 315 detects the loading in memory or reading of any installation instructions 310. In one embodiment, the detector 315 detects the execution of a predetermined installation instruction 310.

At step 360, the interceptor 320 or agent 110 intercepts the execution of the detected installation process or installer 305. The interceptor 320 may intercept the installation responsive to the detector 315. In one embodiment, the agent 110 suspends, stops or pauses the execution at any point in time between the start and end of the installation process. In some embodiments, the agent 110 stops the execution and rolls back any installation activity up until a predetermined check point. In other embodiments, the agent 110 stops the execution prior to any installation instruction being executed. In some embodiments, the agent 110 stops the execution after a predetermined number of installation instructions 310 have been executed or after a predetermined instruction 310 has been executed. In yet another embodiment, the agent 110 suspends the installer 310 before the installer has accessed or read the installer instructions 310.

At step 365, the agent 110 performs any type and form of conflict or incompatibility checking between the components or files identified by the installation instructions 310 and any of the components or files existing, located or stored on the computing device. The comparator 278 may perform this check or comparison responsive to the detector 315 and/or interceptor 320. In one embodiment, the comparator 278 compares every file of the application to be installed via the instructions 310 with similar files existing on the computing device, such as files with the same name, extensions, or of the same type. In another embodiment, the comparator 278 compares each of the components to be installed via the instructions 310 with each of the components currently installed on the computing device 100. In some embodiments, the comparator 278 performs this comparison for each of the instructions 310. In other embodiments, the comparator 278 performs this comparison for some of the instructions 310. For some cases, the comparator 278 may skip detecting conflicts or isolations for a predetermined file or component.

At step 370, the agent via the instruction generator 325 generates one or more isolation instructions to modify the installation process. The instruction generator 325 may operate responsive to the comparator 325 on a per detection or conflict basis. In another embodiment, the instruction generator 325 may operate responsive to the comparator 325 on a batch of detections or conflicts. In one embodiment, the instruction generator 325 may operate responsive to the comparator 325 completing the analysis or search for conflicts. In some embodiments, the instruction generator 325 generates isolation instructions via a manifest file. In one embodiment, the instruction generator 325 generates a manifest file. In another embodiment, the instruction generator 325 generates instructions, directives or content for the manifest file. In other embodiments, the instruction generator 325 generates isolation instructions and inserts these instructions in a suitable location in memory for execution by the installer. In another embodiment, the instruction generator 325 generates isolation instructions and inserts these instructions in a file or storage to be accessed by the installer. In yet one embodiment, the instruction generator 325 generates an instruction for the installer to access or read additional instructions from an installation file 310. In some embodiments, the instruction generator 325 modifies the install instructions 310 loaded in memory.

At step 370, the agent 110 resumes or continues the execution of the installer 305. In one embodiment, the agent 110 continues the intercepted execution of the installer 305 responsive to the instruction generator 325 generating a last instruction or modifying a last instruction. In another embodiment, the agent 110 continues the execution of the installer 305 responsive to the comparator 278 not finding any conflicts. In yet another embodiment, the agent 110 continues the execution of the installer 305 responsive to the comparator 278 finding a last conflict. In some embodiments, the agent 110 continues the execution of the installer 305 after a predetermined time period or upon a predetermined event. In other embodiments, the interceptor 320 continues the execution of the installer responsive to any portion of the agent 110, such as the comparator 278 or the instruction generator 325.

As the agent 110 and/or instruction generator 325 provides these modified instructions transparently to the installer, the installer continues execution with the modified instructions as if these instructions were the original instructions. Furthermore, since the modified instructions use isolation techniques native to or understood by the installer, the installation process continues in a manner that preserves any functionality provided by the installer with regards to isolation as well as repair, uninstalls or other maintenance functionality. Moreover, this adaptive installation technique is provided transparently to the application and the user to provide a seamless install procedure for the application to any user's environment. As a user roams between computing devices having different existing files or installed components, the systems and methods of the adaptive installation process allows the user to install and use the same application dynamically on any of these devices transparently and while avoiding application conflicts.

Although the adaptive installation technique is generally described in connection with the session control system environment described herein, the systems and method for providing adaptive installation may be deployed without the session control system, such as an agent or program on a client or a server. In other embodiments, the functionality of the client agent 120, or any portions thereof, may be deployed via any type and form of appliance, such as a special purpose appliance or device. In yet another embodiment, the adaptive functionality of the client agent 120 may be included with the installer. In further embodiments, the installation instructions may include instructions to execute or trigger the execution of the adaptive installation system and methods described herein.

Furthermore, the adaptive installation technique may be used for the installation of any type of application, program, database, library, script, components, executables, data, files, etc. via any type and form of access method 107. In one embodiment, the adaptive installation technique may be used for installing any fat-client type application on the client. In another example, the adaptive installation technique may be used for the installation of an application in a virtualized environment for any virtual layer or a base layer. In another embodiment, the adaptive installation technique may be used for the deployment, installation or execution of an application streamed to a client. In other embodiments, the adaptive installation technique may be used for installation in a server-based or remote-based computing environment. In yet another embodiment, the adaptive installation technique may be used for installing any add-on, plug-in or component of an application, such as a plug-in or add-on component for any type and form of browser. Moreover, the adaptive installation technique may be executed or used dynamically and seamlessly in response to a user's request for an application, such as in a user based environment.

What is claimed:

1. A method for adaptively modifying an installation process at a time of install to isolate conflicts between components to be installed and existing components, the method comprising the steps of:
(a) detecting, by a client agent, initiation of execution of an installer on a client, the installer obtaining installation instructions via an install file;
(b) intercepting, by the client agent, execution of the installer in response to the detection;
(c) determining, by the client agent, existence of a conflict between each of one or more components identified via the installation instructions and one or more components existing on the client; and
(d) modifying, by the client agent in response to the determination, the installation instructions to include an isolation instruction for each determined conflict; and
(e) continuing, by the client agent, the intercepted execution of the installer using the modified installation instructions.

2. The method of claim 1, wherein step (c) comprises comparing, by the client agent, each component identified in the install file to corresponding components existing on the client.

3. The method of claim 1, wherein step (a) comprises detecting, by the client agent, initiation of execution of a Windows Installer program.

4. The method of claim 1, wherein step (b) comprises suspending, by the client agent, execution of the installer in response to the detection.

5. The method of claim 1, wherein step (c) comprises stopping, by the client agent, execution of the installer in response to the determination.

6. The method of claim 1, wherein step (e) comprises restarting, by the client agent, the intercepted execution of the installer upon completing modifications to the installation instructions for each of the determined conflicts.

7. The method of claim 1, wherein step (d) comprises inserting, by the client agent, in the installation instructions a first isolation instruction in response to determining existence of a first conflict.

8. The method of claim 1, wherein step (d) comprises inserting, by the client agent, in the installation instructions a first isolation instruction identifying a manifest file in response to determining the existence of a first conflict.

9. The method of claim 1, comprising generating, by the client agent, a manifest file in response to determining the existence of a first conflict, the manifest file comprising an Extensible Markup Language structure identifying one or more components to pre-load and a location for each of the one or more components.

10. The method of claim 1, wherein step (e) comprises one of seamlessly or transparently continuing, by the client agent, the intercepted execution of the installer.

11. The method of claim 1, wherein the isolation instruction provides an instruction to resolve a first determined conflict between a first identified component to be installed and a corresponding component existing on the client.

12. The method of claim 1, wherein step (d) comprises modifying, by the client agent, the installation instructions stored in memory.

13. A system for adaptively modifying an installation process at a time of install to isolate conflicts between components to be installed and existing components, the system comprising:
a detector to detect initiation of execution of an installer on a client, the installer obtaining installation instructions via an install file;
an interceptor to intercept execution of the installer in response to response to the detector;
a comparator to compare each of one or more components identified via the installation instructions and one or more components existing on the client to determine existence of a conflict;
an isolation instruction generator to generate an isolation instruction responsive to the comparator; and
an agent to modify the installation instructions to include an isolation instruction for each determined conflict and to continue the intercepted execution of the installer using the modified installation instructions.

14. The system of claim 13, wherein the comparator searches for an existing component on the client corresponding to each component identified in the install file.

15. The system of claim 13, wherein the detector detects initiation of execution of a Windows Installer program.

16. The system of claim 13, wherein one of the interceptor or the agent suspends execution of the installer in response to the detector.

17. The system of claim 13, wherein one of the interceptor or the agent stops execution of the installer in response to the comparator identifying a conflict.

18. The system of claim 13, wherein the isolation instruction generator generates a first isolation instruction in response to determining existence of a first conflict.

19. The system of claim 13, wherein the isolation instruction generator generates a first isolation instruction identifying a manifest file in response to the comparator determining the existence of a first conflict.

20. The system of claim 13, wherein the isolation instruction generator generates a manifest file in response to the comparator determining the existence of a first conflict, the manifest file comprising an Extensible Markup Language structure identifying one or more components to pre-load and a location of each of the one or more components.

21. The system of claim 13, wherein the agent one of seamlessly or transparently continues the intercepted execution of the installation instructions.

22. The system of claim 13, wherein the isolation instruction generator generates an isolation instruction to resolve a first determined conflict between a first identified component to be installed and a corresponding component existing on the client.
